(19) United States
(12) Patent Application Publication
(10) Pub. No.: US 2011/0015948 A1
(43) Pub. Date: Jan. 20, 2011

(54) COMPUTER SYSTEM FOR ANALYZING CLAIMS FILES TO IDENTIFY PREMIUM FRAUD

(76) Inventors: Jonathan Kaleb Adams, Middletown, CT (US); Stephen William Faraclas, Simsbury, CT (US); William Cameron Lewis, Farmington, CT (US); John Albert McGoldrick, Meriden, CT (US)

Correspondence Address: BUCKLEY, MASCHOFF & TALWALKAR LLC, 50 LOCUST AVENUE, NEW CANAAN, CT, 06840, US

(21) Appl. No.: 12/506,038

(22) Filed: Jul. 20, 2009

(51) Int. Cl. G06Q 40/00; G06F 17/28

(52) U.S. Cl. 705/4; 704/2

(57) ABSTRACT

A computer system includes a data storage module. The data storage module receives, stores, and provides access to both aggregate claims file data and insurance policy data. The computer system also includes a computer processor and a program memory. The computer processor executes programmed instructions and stores and retrieves the data stored in the data storage module. A text mining component is coupled to the data storage module, and analyzes unstructured text in the aggregate claims file data to detect indicators of possible premium fraud. A routing module in the computer system routes for investigation insurance policies that correspond to the claim files in which indicators of possible premium fraud were detected.

### FIELD

The present invention relates to computer systems and more particularly to computer systems that analyze information to provide indicators of fraud.

### BACKGROUND

Patent application number WO01/13295 (“the '295 application”), published by the World Intellectual Property Organization (WIPO), names Luk et al. as inventors, and discloses a system and method of detecting insurance premium fraud. As is well known to those who are skilled in the art, premium fraud occurs when an insured or prospective insured conceals or misrepresents information to cause an insurance company to charge a lower premium than the insurer would have charged had it known all the facts. Premium fraud is a particular issue in connection with workers compensation (WC) insurance policies. Premiums for WC policies are typically calculated as a function of the insured's payroll and the types of work done by the insured's employees. Loss experience may also be taken into account in setting WC premiums and may be reflected by an “experience modification” factor. Insureds may commit premium fraud by understating their payroll and/or by misrepresenting the classification of the employees (e.g., by overstating the proportion of employees who are in less hazardous job classes) and/or by concealing incidents in which employees are injured.

FIG. 1A is a simplified example of a conventional “Schedule of Operations” that may be included in a workers compensation insurance policy. The Schedule of Operations illustrates how a premium may be calculated for a workers compensation insurance policy. At 20 in FIG. 1A the classifications for the insured's employees are set forth, with the aggregate amounts of payroll for each classification indicated in column 22, applicable premium rates shown in column 24, and the amount contributed to the total premium for each classification shown in column 26. Further, reference numeral 28 indicates an experience modification factor that is applied to the total class premium 30 to arrive at a bottom line premium amount 33. In this particular example, the experience modification factor is less than 1.00, resulting in a reduction in premium to reflect a favorable loss experience.

In some actual Schedules of Operation, additional factors and adjustments may be included to represent, for example, insurance premium rate regulation policies in the particular jurisdiction to which the WC insurance policy applies.

The system disclosed in the '295 application uses a predictive model (more specifically a neural network) to identify insurance policies in which premium fraud may be present. The predictive model operates on a set of variables that may include: (i) variables derived by comparing the subject policy with other policies in the same category, (ii) variables related to the category of policy, (iii) variables indicative of changes in policy data over time, and (iv) variables related to data reported by the insured.

It is typically the case that claims for workplace injuries are made under WC policies. In handling the claims, employees of the insurer generate claim files (usually computerized) which contain information about the claims. In many insurance companies, there may be hundreds of claim handlers on staff, and each claim handler may write narrative notes in his or her own style as part of the claim files he or she generates. FIG. 1B is a simplified illustrative example of the claim handler's notes portion of a conventional workers compensation claim file. The left hand column 40 contains fields that indicate the date on which each note was entered in the claim file. The right hand column 42 represents unstructured text fields in which the unstructured text making up each note has been entered by the claim handler. The size of each text note may be as long or as short as the claim handler finds to be necessary for the narrative information he or she wishes to insert into the claim file. Although only about a dozen notes are shown in the drawing, in practice a typical claim file may come to include dozens, and even a few hundred claim handler notes. Moreover, for a sizable insured, there may be numerous claim files for claims brought under the insured's workers compensation policy.

The present inventors have recognized that information present in WC claim files may contain indicators of premium fraud that can be detected by techniques that are different from those proposed in the '295 application. This recognition goes beyond the disclosure in the '295 application, which may use claim attributes such as opening and closing dates of the claim, date of injury, nature of injury and part of the body injured, claimant diagnosis, cause of accident, and so forth, but the '295 application does not disclose utilizing narrative notes or the like for detecting premium fraud.

### SUMMARY

A computer system is disclosed which includes a data storage module. Functions performed by the data storage module include receiving, storing and providing access to aggregate claims file data. The aggregate claims file data represents claims made under a number of insurance policies. The aggregate claims file data includes unstructured text fields that contain unstructured text information. In addition, the data storage module also receives, stores and provides access to policy data. The policy data relates to the insurance policies.

The computer system further includes a text mining component that is coupled to the data storage module and determines whether to identify a given one of the insurance policies for referral to an investigation unit. The text mining component makes the determination by analyzing unstructured text information contained in aggregate claims file data for the insurance policy in question. The unstructured text information is analyzed to detect one or more indicators therein of premium fraud.

The computer system also includes a computer processor that executes programmed instructions and stores and retrieves the data related to current claim transactions.

Further included in the computer system is a program memory, which is coupled to the computer processor. The program memory stores program instruction steps for execution by the computer processor.

An output device is also included in the computer system. The output device is coupled to the computer processor and outputs an output indicative of whether the insurance policy in question should be referred to an investigation unit. The computer processor generates the output in accordance with program instructions in the program memory and executed by the computer processor. The output is generated in response to analyzing the unstructured text information contained in the aggregate claims file data for the insurance policy in question.

The computer system further includes a routing module which directs workflow based on the output from the output device.

According to another aspect of the invention, a method of operating a computer system includes storing aggregate claims file data in a computer system. The aggregate claims file data represents claims for workers compensation benefits under a number of workers compensation insurance policies. The aggregate claims file data includes unstructured text fields that contain unstructured text information.

The method further includes storing policy data in the computer system. The policy data relates to the workers compensation policies. In addition, the method includes using in the computer system a text mining tool to define at least one rule for identifying at least one indicator of premium fraud in the unstructured text information. Also, the method includes automatically analyzing the unstructured text information in the stored aggregate claims file data—by using the text mining tool and the rule (or rules)—to select certain ones of the workers compensation policies. The selected workers compensation policies correspond to claims for which the automatic analysis of the unstructured text identified at least one indicator of premium fraud.

Still further, the method includes generating output signals in the computer system. The output signals include portions of the policy data which correspond to the selected workers compensation insurance policies. The output signals also include data that represents the indicator(s) of premium fraud that were identified by the analysis of the unstructured text.

The method also includes outputting the output signals from the computer system.

The computer system and/or method provided according to the invention may detect indicators of premium fraud that are contained in unstructured text in the claims files, and thus may aid in identifying insurance policies that should be audited and/or investigated for possible premium fraud.

With these and other advantages and features of the invention that will become hereinafter apparent, the invention may be more clearly understood by reference to the following detailed description of the invention, the appended claims, and the drawings attached hereto.

### BRIEF DESCRIPTION OF THE DRAWINGS

FIG. 1A is a simplified example of a conventional “Schedule of Operations” that may be included in a workers compensation insurance policy.

FIG. 1B is a simplified illustrative example of the claim handler's notes portion of a conventional workers compensation claim file.

FIG. 1C is a partially functional block diagram that illustrates aspects of a computer system provided in accordance with some embodiments of the invention.

FIG. 2 is a block diagram that illustrates a computer that may form all or part of the system of FIG. 1C.

FIG. 3 is a block diagram that provides another representation of aspects of the system of FIG. 1C.

FIG. 4 is a flow chart that illustrates a process that may be performed in the computer system of FIGS. 1C, 2 and 3.

FIG. 5 is an example screen display that shows a graphical representation of a portion of a phrase definition defined in accordance with an aspect of the invention for analyzing unstructured text in claims file data.

FIG. 6 is similar to FIG. 1B, but showing how a text mining tool configured in accordance with the present invention may detect an indicator of premium fraud in unstructured text included in claims file data.

FIG. 7 is a flow chart that illustrates an example process for scoring, in accordance with aspects of the present invention, insurance policies for which indicators of premium fraud are detected.

### DETAILED DESCRIPTION

In general, and for the purposes of introducing concepts of embodiments of the present invention, a text mining tool may be employed in a computer system to detect indicators of premium fraud in claims files generated for claims brought under insurance policies. Techniques described herein are particularly applicable to workers compensation (WC) insurance policies, but may be applied to other types of insurance policies as well. The text mining tool may be used to define rules for identifying policies that should be referred for investigation and/or audit. The rules may define significant phrases that may appear in unstructured text fields in the claims files. The rules may be defined so as to capture most or all likely variations of the significant phrases. The phrases may be indicative of information collected by claim handlers that tends to suggest that the insured may have understated its payroll and/or concealed workplace injuries in order to fraudulently obtain lower premiums for WC coverage. The rules may reflect expert knowledge concerning how and in what variations the indicators of premium fraud may be phrased.

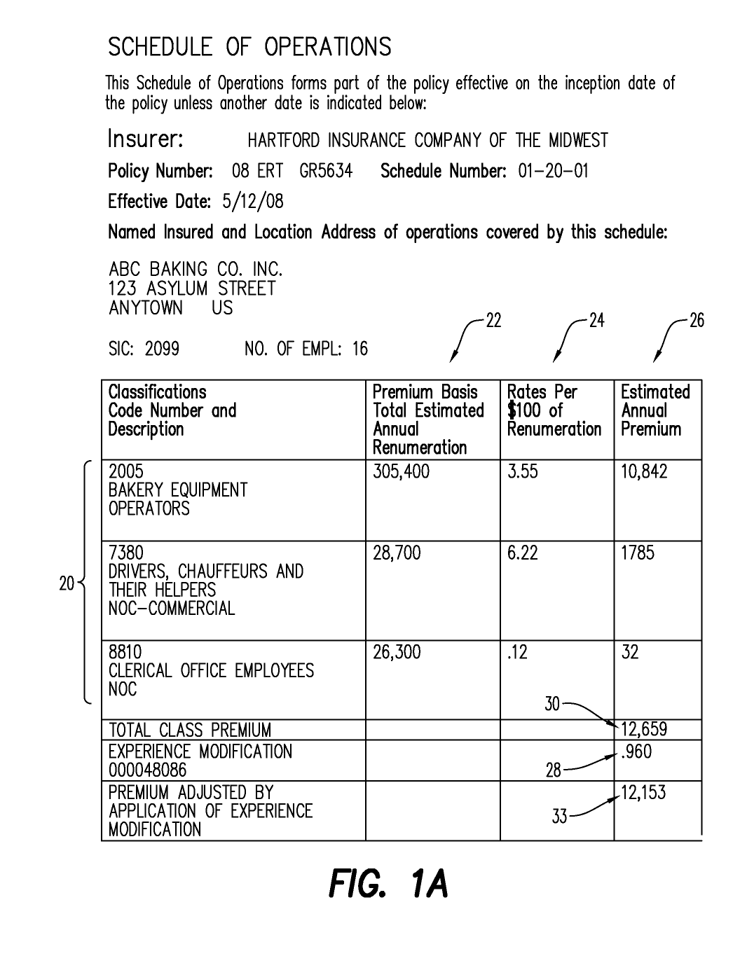

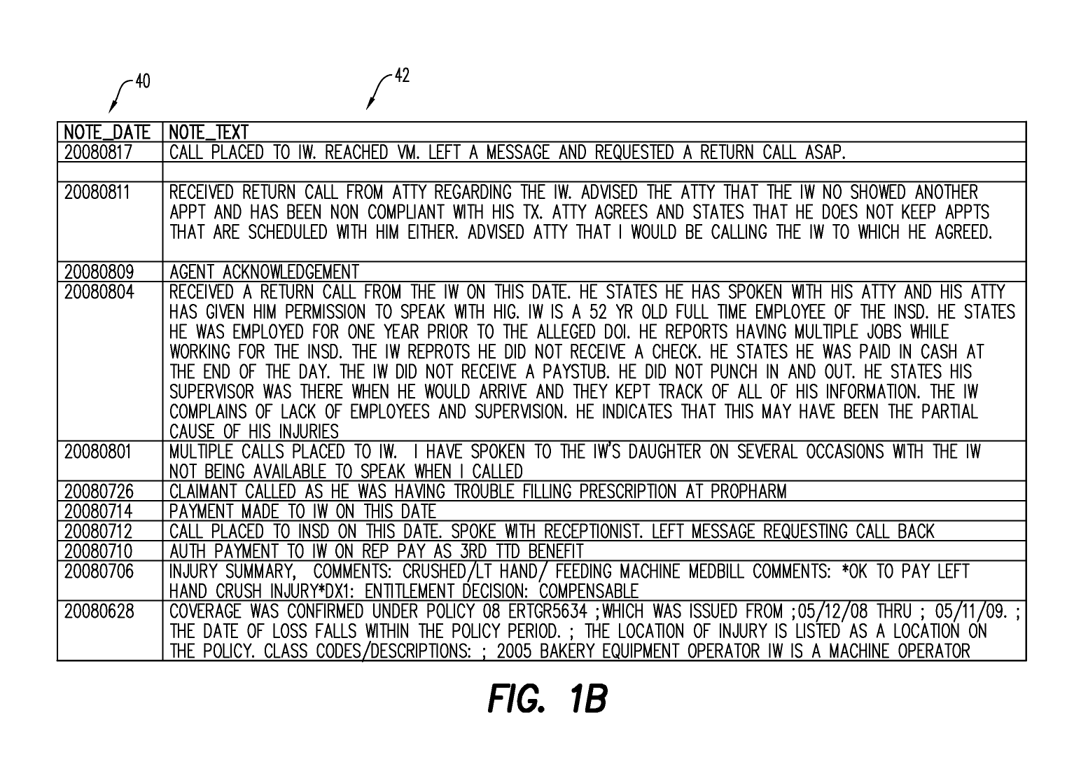

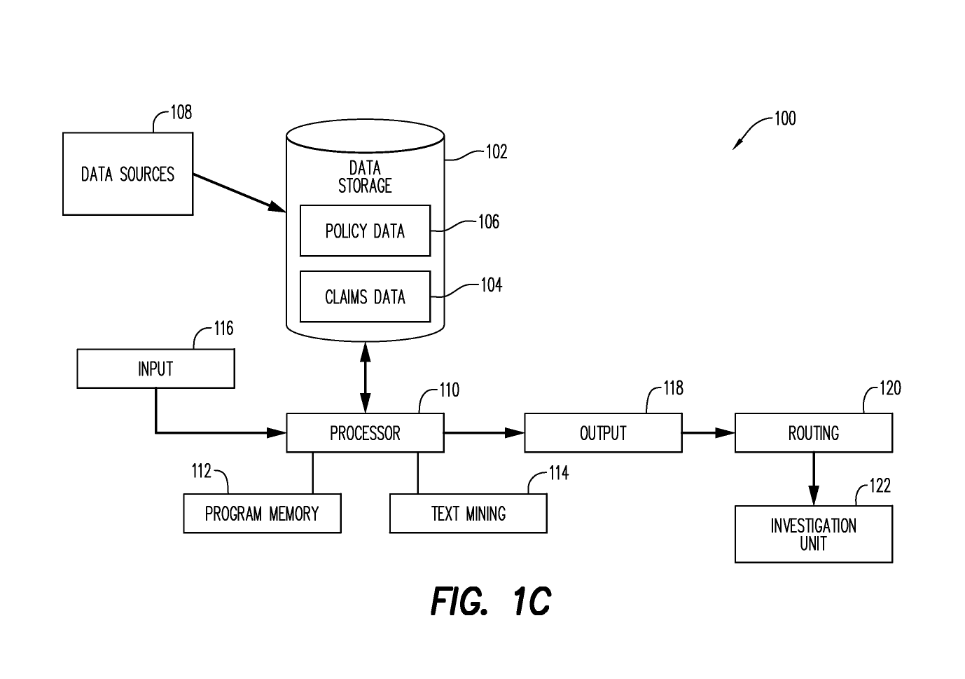

Features of some embodiments of the present invention will now be described by first referring to FIG. 1C. FIG. 1C is a partially functional block diagram that illustrates aspects of a computer system 100 provided in accordance with some embodiments of the invention. For present purposes it will be assumed that the computer system 100 is operated by an insurance company (not separately shown) for the purpose of referring workers compensation policies to an investigation unit for audit and/or investigation for possible premium fraud. As will be seen, the computer system 100 analyzes claim files for claims brought under the WC policies to identify those policies which are most likely to be worth investigating/auditing.

The computer system 100 includes a data storage module 102. In terms of its hardware the data storage module 102 may be conventional, and may be composed, for example, by one or more magnetic hard disk drives. A function performed by the data storage module 102 in the computer system 100 is to receive, store and provide access to aggregate claims file data (represented by block 104). The aggregate claims file data 104 may be in the form of numerous individual claim files and may represent claims brought under some or all of the WC policies in force with an insurance company that operates the computer system 100. In some embodiments, the claim files may be segregated/grouped by the policies under which the claims were brought. The claim files themselves may be conventional in terms of their format and their contents. As is conventional, the claim files may include one or more unstructured text fields. The unstructured text fields may be “free form” fields in which text is stored. The text may represent one or more of the following: the claim handler's verbal assessment of the claim; the claim handler's notes and/or summaries of the claim handler's conversations with the claimant, with representatives of the policy holder, or with other individuals; text incorporated into the file from electronic mail messages sent or received by the claim handler; comments on the file by the claim handler's supervisor(s); and/or sentences and/or phrases from other sources.

In addition, the aggregate claims file data may include conventional fields related to, for example, claim identification number, claimant's name and contact information, date of injury, diagnosis, treating physician, benefits paid, policy number (to identify the policy under which the claim was brought), claim handler's name/employee identification number, claims office to which the claim is assigned, and so forth. Those who are skilled in the art will be aware of other components of the typical WC claim file in addition to those listed in this paragraph.

In some embodiments, the aggregate claims file data 104 represents the entire claim file for every claim brought under any WC policy. In other embodiments, every claim file is represented by the aggregate claims file data 104, but only partially. For example, in some embodiments each WC claim file is represented only by excerpts therefrom such as all unstructured text plus the claim identification number and the policy number.

Another function performed by the data storage module 102 in the computer system 100 is to receive, store and provide access to policy data (represented by block 106). The policy data may include the respective files for the WC policies in force with the insurer, and may for example include such typical data fields as policy number, name and address of the insured, data used to calculate the premium (e.g., amount of payroll, classifications of employees, experience modification factor, SIC code, etc.), and other information conventionally stored in a computer file for a WC insurance policy.

The policy data 106 and the aggregate claims file data 104 may originate from one or more data sources 108. The data source(s) 108 may be included in the computer system 100 and coupled directly or indirectly to the data storage module 102. The data source(s) 108 may, for example, be one or more databases of claims and/or policy information maintained in a central computer facility (not separately shown) for the insurer. More indirectly, the source of the policy data 106 and the aggregate claims file data 104 may be personal computers (not shown) or other computing devices (not shown) operated by claim handlers, underwriters and/or administrative employees of the insurer who generate or input the information to be stored in claim files and/or policy data files.

The computer system 100 also may include a computer processor 110. The computer processor 110 may include one or more conventional microprocessors and may operate to execute programmed instructions to provide functionality as described herein. Among other functions, the computer processor 110 may store and retrieve aggregate claims file data 104 and policy data 106 in and from the data storage module 102. Thus the computer processor 110 may be coupled to the data storage module 102.

The computer system 100 may further include a program memory 112 that is coupled to the computer processor 110. The program memory 112 may include one or more fixed storage devices, such as one or more hard disk drives, and one or more volatile storage devices, such as RAM (random access memory). The program memory 112 may be at least partially integrated with the data storage module 102. The program memory 112 may store one or more application programs, an operating system, device drivers, etc., all of which may contain program instruction steps for execution by the computer processor 110.

The computer system 100 further includes a text mining component 114. In certain practical embodiments of the computer system 100, the text mining component 114 may effectively be implemented via the computer processor 110, one or more application programs stored in the program memory 112, and one or more text mining rules defined by an individual (not shown) who operates, programs and/or configures the computer system 100. Example processes for defining text mining rules in accordance with aspects of the invention, and example text mining rules resulting from such processes, will be described below.

In some embodiments, the text mining component may be implemented with a suitable commercially available text mining tool or program. One suitable text mining tool is commercially available from Attensity Group, Palo Alto, Calif., and is referred to as a “Knowledge Engineering Workbench” (KEWB).

Still further, the computer system 100 may include an input device 116. The input device 116 may be coupled to the computer processor 110 (directly or indirectly) and may be operable by an individual operator/programmer for interacting with the text mining component 114 for the purpose of defining one or more text mining rules.

In addition, the computer system 100 may include an output device 118. The output device 118 may be coupled to the computer processor 110. A function of the output device 118 may be to provide an output that is indicative of whether (based on analysis performed by the text mining component 114) a particular one of the WC policies should be referred to an investigation unit. The output may be generated by the computer processor 110 in accordance with program instructions stored in the program memory 112 and executed by the computer processor 110. More specifically, the output may be generated by the computer processor 110 in response to analysis of unstructured text fields (not separately shown) in the aggregate claims file data 104 by the text mining component 114. In some embodiments, the output device may be implemented by a suitable program or program module executed by the computer processor 110 in response to operation of the text mining component 114.

Still further, the computer system 100 may include a routing module 120. The routing module 120 may be implemented in some embodiments by a software module executed by the computer processor 110. The routing module 120 may have the function of directing workflow based on the output from the output device 118. Thus the routing module 120 may be coupled, at least functionally, to the output device 118. In some embodiments, for example, the routing module 120 may direct workflow by referring, to an investigation unit 122, WC policies for which it was the case that the text mining component 114 identified one or more indicators of premium fraud in one or more of the corresponding claim files. In particular, the WC policies for which premium fraud indicators were found may be referred to one or more subject matter experts who are employed in the investigation unit 122. The investigation unit 122 may be a part of the insurance company that operates the computer system 100, and the subject matter expert(s) may be employees of the insurance company.

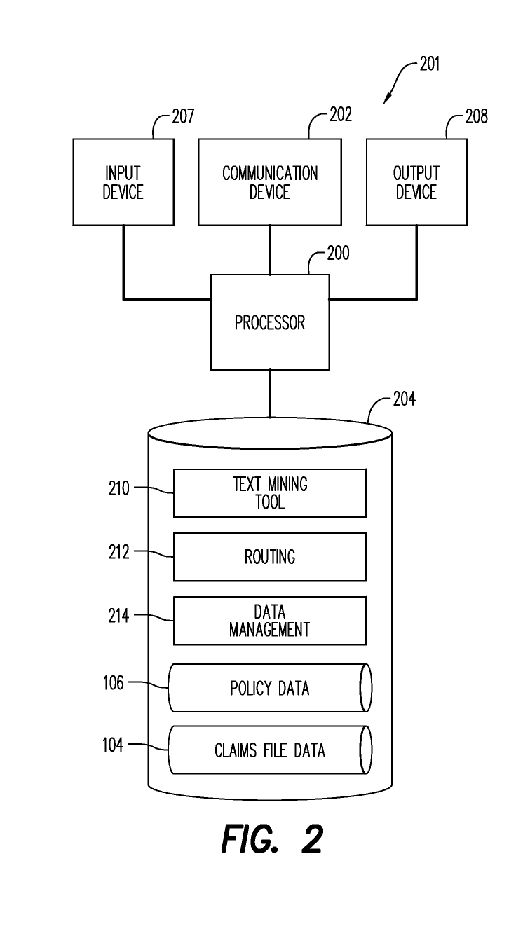

FIG. 2 is a block diagram that illustrates a computer 201 that may form all or part of the system 100 of FIG. 1C.

As depicted, the computer 201 includes a computer processor 200 operatively coupled to a communication device 202, a storage device 204, one or more input devices 207 and an output device 208. Communication device 202 may be used to facilitate communication with, for example, other devices (such as personal computers—not shown in FIG. 2—assigned to individual employees of the insurance company; and/or one or more server computers, such as server computers that function as central repositories of claims and/or policy information for the insurance company). The input device(s) 207 may comprise, for example, a keyboard, a keypad, a mouse or other pointing device, a microphone, knob or a switch, an infra-red (IR) port, a docking station, and/or a touch screen, and may include the input device 116 referred to above in connection with FIG. 1C. The input device(s) 207 may be used, for example, to enter information and/or to control operation of the computer 201. Output device 208 may comprise, for example, a display (e.g., a display screen) a speaker, and/or a printer.

The computer processor 200 may, for example, correspond to the computer processor 110 described above in conjunction with FIG. 1C.

Storage device 204 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium.

In some embodiments, the hardware aspects of the computer 201 may be entirely conventional.

Storage device 204 stores one or more programs or portions of programs (at least some of which are indicated by blocks 210-214) for controlling processor 200. Processor 200 performs instructions of the programs, and thereby operates in accordance with the present invention. The programs comprise program instructions (which may be referred to as computer readable program code means) that contain processor-executable process steps of computer 201, including, in some cases, process steps that constitute processes provided in accordance with principles of the present invention, as described in more detail below.

In some embodiments, the programs may include a program or program module 210 that functions as a text mining tool, such as the text mining tool 114 referred to above in conjunction with FIG. 1C. Apart from rule definition, or other programming or configuration provided in accordance with teachings in this disclosure, the text mining tool may be substantially implemented with suitable commercially available software as referred to above.

Another program or program module stored on the storage device 204 is indicated at block 212 and is operative to allow the computer 201 to route or refer WC policies to insurance company/investigative unit employees as appropriate based on the results obtained by applying the text mining component 114 to unstructured text fields in the aggregate claims file data 104.

Still another program or program module stored on the storage device 204 is indicated at block 214 and engages in database management and like functions related to data stored on the storage device 204. There may also be stored in the storage device 204 other software, such as one or more conventional operating systems, device drivers, communications software, etc. The aggregate claims file data 104 and the policy data 106, as previously described with reference to FIG. 1C, are also shown in FIG. 2 as being stored on the storage device 204.

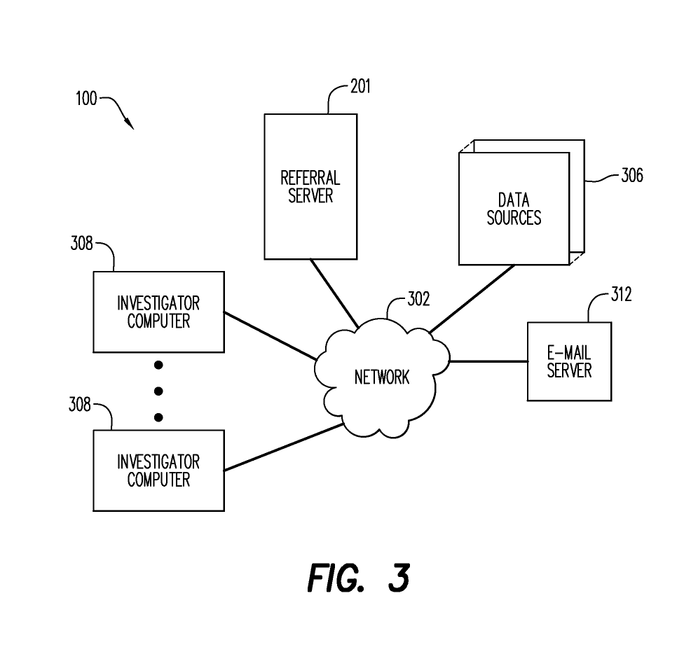

FIG. 3 is another block diagram that presents the computer system 100 in a somewhat more expansive or comprehensive fashion (and/or in a more hardware-oriented fashion).

The computer system 100, as depicted in FIG. 3, includes the computer 201 of FIG. 2. The computer 201 is depicted as a “referral server” in FIG. 3, given that a function of the computer 201 is to selectively refer WC policies to an investigation unit of the insurance company for investigation and/or audit. As seen from FIG. 3, the computer system 100 may further include a conventional data communication network 302 to which the computer/referral server 201 is coupled.

FIG. 3 also shows, as parts of computer system 100, data source(s) 306, which are coupled to the data communication network 302. The data source(s) 306 may include the data sources 108 discussed above with reference to FIG. 1C. More generally, the data source(s) 306 may encompass any and all devices conventionally used, or hereafter proposed for use, in gathering, inputting, receiving and/or storing information for insurance company claim files or policy files.

Still further, FIG. 3 shows, as parts of the computer system 100, personal computers 308 assigned for use by members of the insurance company's investigation unit. The personal computers 308 are coupled to the data communication network 302.

Also included in the computer system 100, and coupled to the data communication network 302, is an electronic mail server computer 312. The electronic mail server computer 312 provides a capability for electronic mail messages to be exchanged among the other devices coupled to the data communication network 302.

Thus the electronic mail server computer 312 may be part of an electronic mail system included in the computer system 100.

The computer system 100 may also be considered to include further personal computers (not shown), including, e.g., computers which are assigned to individual claim handlers, supervisors of claim handlers, administrative personnel or other employees of the insurance company. These computers as well may be coupled to the data communication network 302.

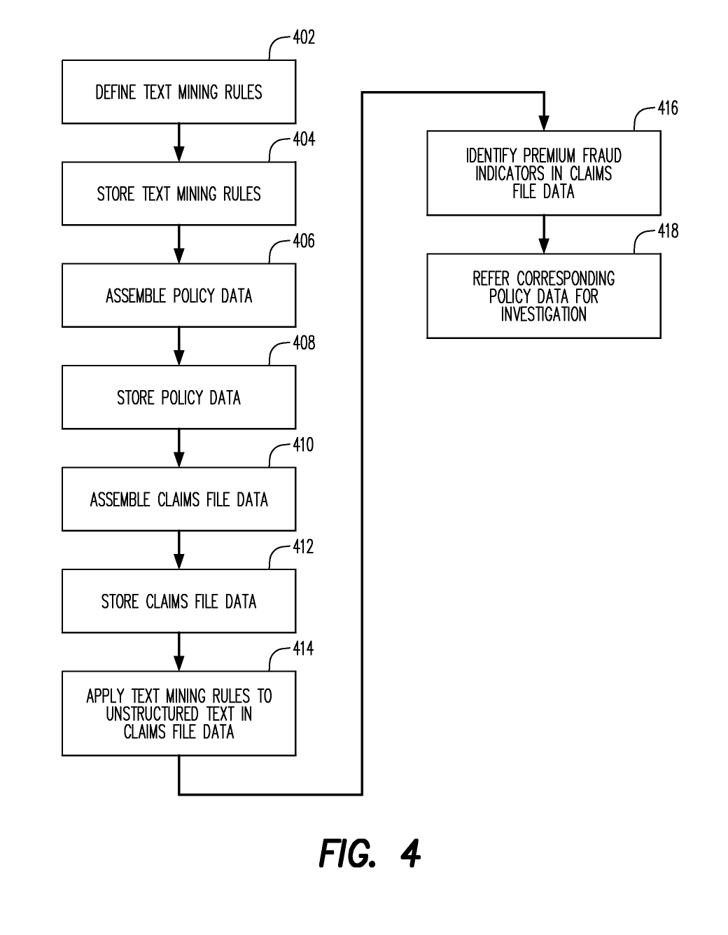

FIG. 4 is a flow chart that illustrates a process that may be performed in the computer system 100/computer 201 of FIGS. 1C, 2 and 3.

At 402 in FIG. 4, one or more text mining rules are defined. This may be done, for example, by a specialist in detection of premium fraud, who may do so by operating input device 116/207 in order to interact with text mining component 114/text mining tool 210 in the computer system 100/computer 201.

It is well known that understatement of payroll and/or concealment of workplace injuries by the insured are significant mechanisms by which insureds may commit premium fraud with respect to WC insurance policies. The present inventors have recognized that unstructured text fields in WC claim files may provide indications of many forms of payroll understatement or concealment of workplace injuries. With the techniques developed by the present inventors, information that is useful for detecting premium fraud may be detected in claim handlers' notes and other unstructured text fields in claim files even though the claim handlers' ways of expressing themselves and composing their notes may vary substantially from one claim handler to another and thus from one claim file to another.

In accordance with aspects of the present invention, text mining rules may be defined at step 402 to configure/program the text mining tool to detect many indications of premium fraud. These indications may take the form of certain verbal phrases or terms.

In an example embodiment of the invention, the text mining tool is configured with a number of different text mining rules, each of which corresponds to a respective phrase definition. In this particular example embodiment, the phrase definitions are denoted by the following:

(1) “claimant lacks documentation”;

(2) “claimant not employee”;

(3) “claimant paid in cash”;

(4) “employer paid unreported bill”;

(5) “employer won't confirm info”;

(6) “no ssn”.

Each of above denotations of phrase definitions may themselves be considered as a “root phrase” as well as a label for the corresponding phrase definition.

In addition to its root phrase, each phrase definition may also include one or more alternative phrase forms that have substantially or essentially the same meaning as the root phrase.

The phrase definition denoted by the root phrase “claimant lacks documentation” includes the following alternative phrase forms in this particular example embodiment of the invention:

(i) “does not have any payroll records”

(ii) “no wage documentation”

(iii) “undocumented worker”

(iv) “has not provided us with a wage report”

(v) “did not provide wage report”

It will be appreciated that each of these five alternative phrase forms has essentially the same meaning, which is that the claim handler was not able to obtain documentary records showing that the claimant was employed by the policy holder. This is an indicator that the policy holder may be maintaining employer-employee relationships with individuals who do not appear in the policy holder's records. Thus the policy holder may be understating its payroll.

The phrase definition denoted by the root phrase “claimant not employee” includes the following alternative phrase forms in this particular example embodiment of the invention:

(i) “claimant employed by subcontractor”;

(ii) “paid through 1099”;

(iii) “claimant not an employee”;

(iv) “not all of the employees are on the books”;

(v) “not on the payroll”;

(vi) “never worked for them”;

(vii) “contract basis”;

(vii) “independent contractor”.

All of these alternative phrase forms convey that the policy holder has chosen, perhaps inappropriately, to treat the claimant as an independent contractor or as an employee of an independent entity under contract to the policy holder, or that the policy holder has otherwise tended to deny or conceal any legal employment relationship with the claimant. This too may have been intended, or at least may have had the effect, of understating the policy holder's payroll for purposes of calculating the premium for the WC policy.

The phrase definition denoted by the root phrase “claimant paid in cash” includes the following alternative phrase forms in this particular example embodiment of the invention:

(i) “pay their employees off the books”;

(ii) “pay their employees under the table”;

(iii) “pay their employees in cash”;

(iv) “cash payments”

These alternative phrase forms all convey the meaning that the policy holder has paid the claimant through a mechanism other than regular payroll check. As in the case of the other phrase definitions, this is an indication that the policy holder has omitted employees from the official payroll records and thus has understated the policy holder's payroll.

The phrase definition denoted by the root phrase “employer paid unreported bill” includes the following alternative phrase forms in this particular example embodiment of the invention:

(i) “employer made unreported medical bill payment”;

(ii) “employer paid medical bills without reporting them”;

(iii) “employer paid unreported medical bill”;

(iv) “employer has made medical bill payment without reporting loss”;

(v) “employer paid medical bills under the table”;

(vi) “employer paid medical bills off the books”.

The alternative phrase forms for this phrase definition all tend to indicate that the policy holder has provided benefits or reimbursement for injury to or on behalf of the claimant informally and outside of the workers compensation system. This in turn may be an indication that the policy holder has engaged in misrepresentation or concealment either as to classification of employees or as to the policy holder's loss experience.

The phrase definition denoted by the root phrase “employer won't confirm info” includes the following alternative phrase forms in this particular example embodiment of the invention:

(i) “employer will not confirm information”;

(ii) “employer refuses to confirm wage”.

Both of these alternative phrase forms are indications that the claim handler has had difficulty obtaining basic information from the policy holder, and thus may indicate that the policy holder is concealing information relevant to premium setting for the WC policy.

The phrase definition denoted by the root phrase “no ssn” includes the following alternative phrase forms in this particular example embodiment of the invention:

(i) “no ssn”;

(ii) “does not have an ssn”.

The term “ssn” in this phrase definition refers to the claimant's lack of a Social Security number, and again is an indication of possible irregularities in the policy holder's hiring practices, which again is an indication that the policy holder may be understating its payroll.

In this particular example embodiment, the text mining tool may be employed to define each alternative phrase form by concatenating several terms or as one of several sequences of terms. In some cases the phrase form in question may simply be the constituent words of the phrase, in sequence. In other cases, at least some of the terms making up the phrase form may themselves be defined, as for example by a Boolean combination of other terms. To give one example, the alternative phrase form “does not have any payroll records” may be defined by use of the text mining tool as a concatenation of the terms “WILL_NOT”, “HAVE”, “ANY”, “ADJECTIVE”, “WAGE” and “REPORT”. The term “WILL_NOT”, in turn, may be defined as a Boolean combination of the phrases “will_not”, “cannot”, did_not”, “has_not”, etc., joined by logical “OR” functions; and the term “ADJECTIVE” may be a wild card term that corresponds to any word or phrase that is an adjective.

Similarly encompassing definitions may be generated for some or all of the other alternative phrase forms listed therein and for the constituent terms which make up the alternative phrase forms. It is within the abilities of those who are skilled in the art to provide, in the text mining tool, effective definitions for the types of phrase forms and terms described herein.

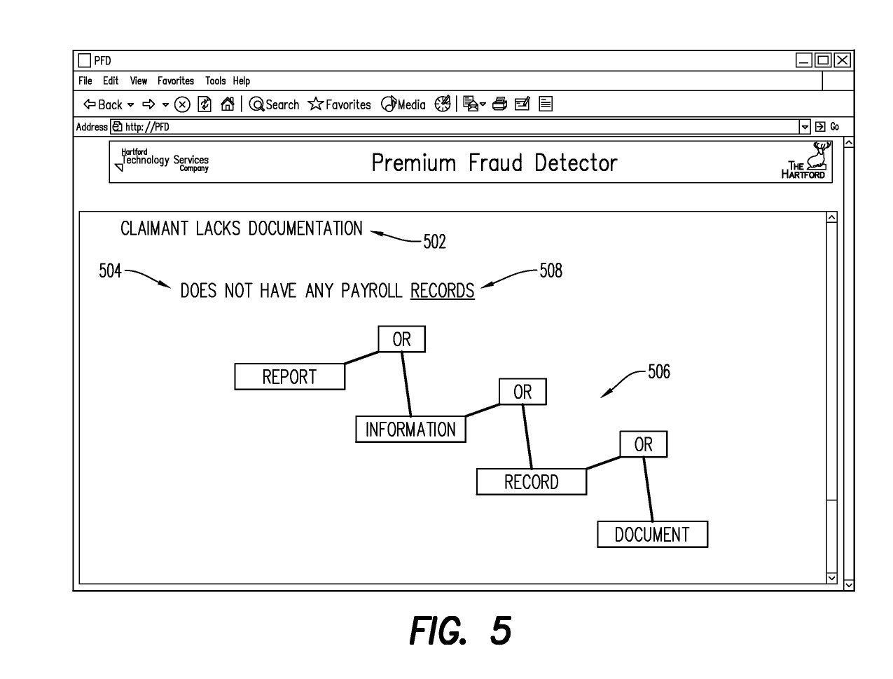

FIG. 5 is an example screen display that shows a graphical representation of a portion of a phrase definition defined in accordance with an aspect of the invention for analyzing unstructured text in claims file data. In the screen display of FIG. 5, a root phrase is shown at 502, and a corresponding alternative phrase form is shown at 504. Reference numeral 506 indicates a graphical representation of a Boolean definition of a phrase term underlined at 508. In accordance with aspects of the present invention, similar definitions of phrase terms may be graphically constructed as needed for other alternative phrase forms and for other root phrases.

In addition to the incorporation of synonyms into the phrase definition, as described above, common typographical errors that may be input for the concatenated terms may also be incorporated in the phrase definition.

To make explicit what has previously been implicit, each phrase definition provided as discussed above may be part of a text mining/analysis rule such as “Report each claim file that includes [defined phrase]”. In addition or alternatively, each rule may call for reporting the corresponding WC policy and/or highlighting the portion of the unstructured text in the claim file which matches the defined phrase. In addition, the rule may also call for reporting the root phrase for which a match was detected. Each rule may operate to cause the text mining tool to detect the root phrase and similar phrases or variations thereof.

The set of text mining rules provided as an example hereinabove are representative of just one possible embodiment. Many variations or alternative sets of rules are possible and are contemplated by aspects of the present invention.

In some embodiments, the text mining rules are defined “manually” by a human expert. In addition or alternatively, text mining rules may be generated by training a predictive model, or by another artificial intelligence program, on the basis of a corpus of unstructured text from claims files for known fraudulent and non-fraudulent WC policies.

At 404, the text mining rules defined at step 402 may be stored in the computer system 100/computer 201.

At 406, the policy data 106 is assembled. This may be done, for example, by importing it from a central policy data repository computer (not shown apart from data sources 108/306) that is maintained and operated by the insurance company.

At 408, the policy data 106 may be stored in the computer system 100/computer 201.

At 410, the aggregate claims file data 104 is assembled. This may be accomplished, for example, by importing computerized claim files from a central claims records repository computer (not shown apart from data sources 108/306) that is maintained and operated by the insurance company.

At 412, the aggregate claims file data 104 may be stored in the computer system 100/computer 201.

At 414, the text mining component 114/text mining tool 210 analyzes the unstructured text fields in the aggregate claims file data 104 by using the text mining rules defined at 402 and stored at 404. In doing so, the text mining component 114/text mining tool 210 identifies indicators of premium fraud in the aggregate claims file data 104 (step 416) by detecting phrases in the unstructured text fields that match the defined phrases in the text mining rules. The identification of the indicators of premium fraud may be evidenced by the text mining component 114/text mining tool 210 generating a report of such indicators by WC policy number and claim number. The report may also indicate what rules were triggered (i.e., what defined phrases were detected), how many times, and in how many different claim files for a given policy.

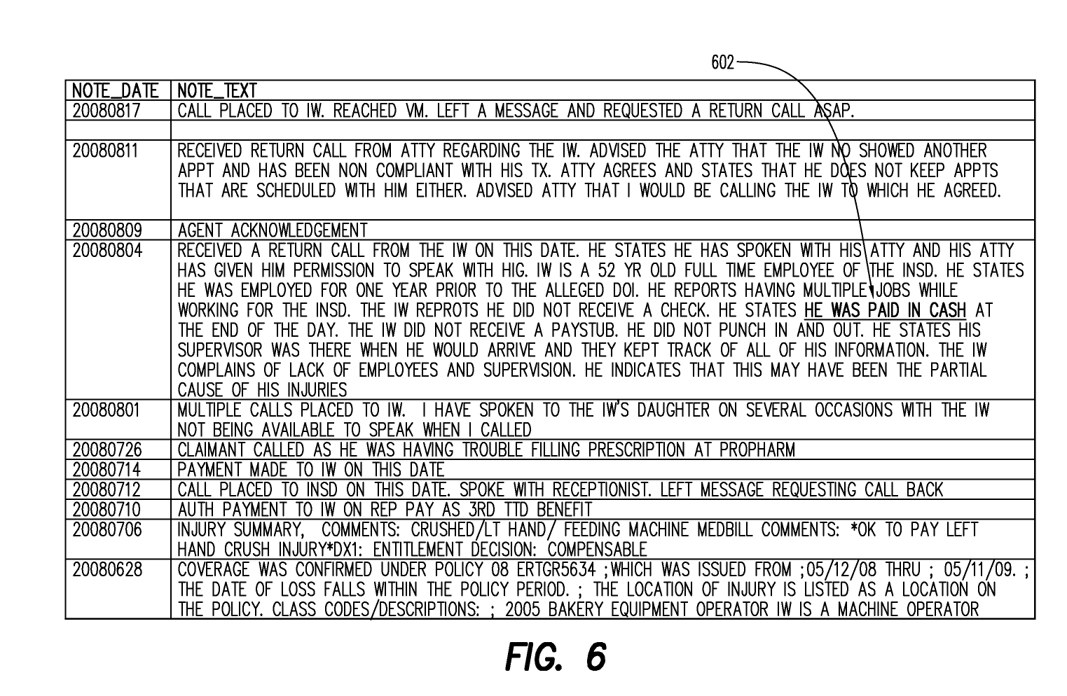

FIG. 6 is similar to FIG. 1B, but showing how the text mining component 114/text mining tool 210 may detect an indicator of premium fraud in unstructured text included in claims file data. In particular, a phrase which matches a text mining rule defined at step 402 is indicated at 602 in FIG. 6. It is assumed for this example that the text mining component 114/text mining tool 210 has detected the matching phrase 602 (“HE WAS PAID IN CASH”) and that, as a result, the computer system 100/computer 201 presents the screen display shown in FIG. 6. In this example, the matching phrase 602 appears in the screen display in bold font and with underlining to draw the user's attention to the detected matching phrase. In addition to or instead of bold font and/or underlining, the matching phrase 602 may alternatively be presented in a contrasting color relative to the balance of the text, and/or may be made conspicuous to the user in some other way.

In some embodiments, the computer system 100/computer 201 may generate scores and/or priority rankings for the policies for which indicators of premium fraud were identified by the text mining analysis. The scoring and/or ranking may be performed in accordance with an algorithm designed by a human expert or alternatively may come about by operation of a predictive model which has been trained to determine how likely it is that premium fraud has occurred based on fraud indicators identified by the text mining component 114/text mining tool 210. In some embodiments, the predictive model, if present, may also take into consideration attributes of the WC insurance policies in question, such as size of the insured company, how long the policy has been in force, SIC code for the insured, etc.

In some embodiments, the ranking/scoring algorithm, if present, may for example base the ranking/scoring on which defined phrases were detected and/or how often particular defined phrases were detected. In addition or alternatively, the ranking/scoring algorithm may estimate the amount of premium that may have been evaded by the policy holder in question, and may base the ranking of policies to be referred for audit at least in part on the estimated premium evaded.

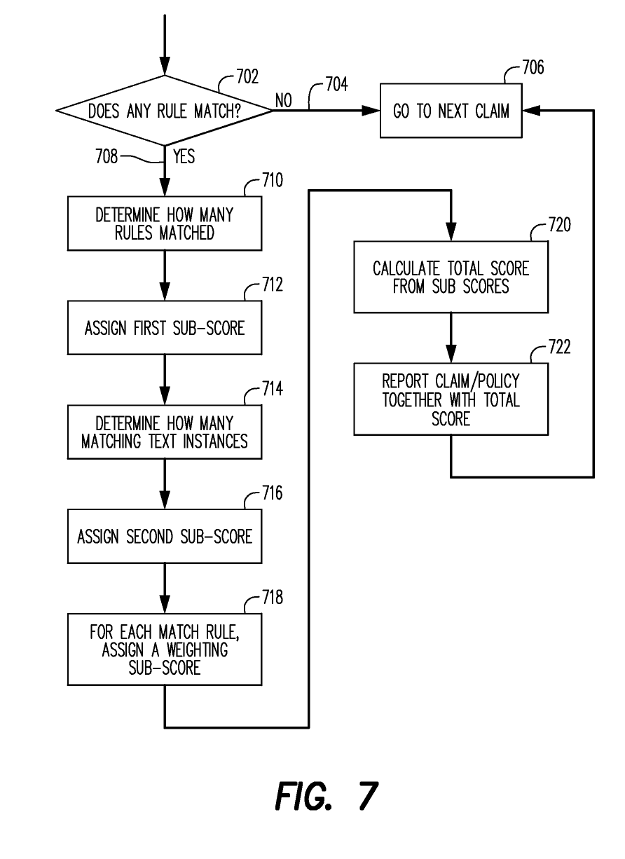

FIG. 7 is a flow chart that illustrates an example process for scoring, in accordance with aspects of the present invention, insurance policies for which indicators of premium fraud are detected.

At decision block 702 in FIG. 7, the computer system 100/computer 201 determines, for the current claim file being analyzed, whether there is at least one match in the unstructured text data for at least one of the text mining rules. If not, as indicated by branch 704, then the computer system 100/computer 201 goes on to analyze the claim file for the next claim, as indicated at block 706.

However, if a positive determination is made at decision block 702 (i.e., if there is at least one match for at least one text mining rule), then the process advances via branch 708 to block 710. At block 710, the computer system 100/computer 201 determines how many of the text mining rules produced matches in the unstructured text in the current claim file. Next, at block 712, the computer system 100/computer 201 assigns a first sub-score to the claim file (and accordingly to the corresponding insurance policy) based on the number of rules that were matched.

Block 714 follows block 712. At block 714, the computer system 100/computer 201 determines a total number of phrases (occasions) in the unstructured text which were found to match at least one of the text mining rules. Then, at block 716, a second sub-score is assigned to the claim/policy in accordance with the total number of matching phrases that was found at block 714.

Block 718 follows block 716. At block 718, for each rule that produced a match, an additional sub-score is assigned to the claim/policy. For example, some rules may be deemed more likely than others to indicate premium fraud, and thus may result in a higher sub-score being assigned in connection with block 718.

At block 720, a total score for the claim/policy is calculated based on all of the above mentioned sub-scores. In some embodiments, this may be done by simply summing all of the sub-scores. In other embodiments, the total score may be calculated as a weighted sum of the sub-scores. In still other embodiments, other types of calculations or algorithms may be used to calculate the total score from the sub-scores.

Next, at block 722, the computer system 100/computer 201 reports the claim/policy to the user (or includes the claim/policy in a report) along with the total score calculated at 720. Then the process advances to analyze the claim file for the next claim (block 706).

In some embodiments, the policies to be referred for investigation may be ranked on the basis of the scores for each policy generated by the process illustrated in FIG. 7. The computer system 100/computer 201 may produce a report of those policies, ranked as described in the preceding sentence.

The scoring process illustrated in FIG. 7 is just one of many different scoring processes that may be employed. According to another scoring process, for example, the number of phrases in the unstructured text that match at least one text mining rule may be tallied for each claim, and the ranking for the claim may simply be the tally of matching phrases.

Referring once more to FIG. 4, at block 418 the computer 201 makes a routing decision with respect to one or more of the WC policies based on results obtained by the text mining. The routing decision may be whether to refer the WC policies to the insurance company's investigation unit for audit or investigation relative to possible premium fraud.

In some embodiments, the computer system 100/computer 201 may cause the WC policies referred to the investigation unit to be queued according to rankings or scores provided by a ranking/scoring algorithm or by a predictive model. In other embodiments, the WC policies to be referred may simply be included in a report sent by the computer system 100/computer 201 to the investigation unit 122 or to a member thereof. The report itself may reflect ranking, scoring, etc., such that WC policies are prioritized for investigation or audit based on rankings and/or scores that the computer system 100/computer 201 has assigned to the WC policies. The report may contain links to the corresponding portions of the policy data 106 for the policies that are being referred and/or to the portions of the aggregate claims file data 104 in which the indicators of premium fraud were detected.

According to the above-disclosed techniques, insurance policies are identified for investigation for premium fraud based on analysis of unstructured text in the corresponding claim files. However, in other embodiments, other information concerning the policies or claims may also be used in identifying policies for premium fraud investigation. For example, the policy data and the aggregate claims file data includes so-called “structured data”, which is data that appears in structured data fields and that may be represented by codes, numerical information, text strings of limited length, etc. Examples of such data include, but are not limited to, policy number, SIC code (Standard Industrial Classification), date of injury and regulatory state. The structured data included in the policy data and/or in the aggregate claims file data may be used in addition to the unstructured text in the aggregate claims file data for the purpose of identifying policies for premium fraud investigation.

Different types of structured data may be useful in different ways in connection with identifying policies for premium fraud investigation. For example, the date of injury may aid in prioritizing policies for investigation, because a more recent injury may present a greater opportunity for recovery of lost premiums because the insured is more likely to still be a current policy holder.

In some embodiments, some or all of the unstructured text may be in one language, such as Spanish, while the text mining tool may operate on the basis of text mining rules in another language, such as English. Accordingly, the computer system 100/computer 201 may be programmed with a language translation application to enable the computer system 100/computer 201 to translate unstructured text from one language to another.

By virtue of the above-described programming with respect to scoring claims/policies, analyzing structured aspects of policy data, and/or language translation, processor 200 may constitute one or more functional components-such as a scoring component, a policy data analysis component, and/or a language translation component of the computer system 100/computer 201. By virtue of interrelationships among the software application programs that control the computer system 100/computer 201, these functional components may be functionally coupled to other functional components of the computer system 100/computer 201 as referred to above, particularly in conjunction with FIG. 1C.

In some embodiments, some or all of the above-mentioned communications among components of the computer system 100 may be via the electronic mail system referred to above in conjunction with FIG. 3. For example, a report of WC policies referred for investigation for possible premium fraud may be sent via electronic mail from the referral server 201 (FIG. 3) to one or more of the investigator computers 308.

Up to this point, the principles of the invention have been illustrated primarily with an example application to detecting indications of potential premium fraud with respect to workers compensation policies. However, application of the invention is not limited to workers compensation insurance. In alternative embodiments, the principles of the present invention may be applied to other types of insurance policies, including for example automobile liability and/or casualty insurance. With respect to various types of insurance policies, policy data and aggregate claims file data may be assembled and text mining analysis may be applied to unstructured text fields in the aggregate claims file data to detect verbal indicators of premium fraud. Upon detection of such indicators, the corresponding policy or policies may be referred to an investigation unit for investigation with respect to possible premium fraud.

The process descriptions and flow charts contained herein should not be considered to imply a fixed order for performing process steps. Rather, process steps may be performed in any order that is practicable.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A computer system comprising:
a data storage module for receiving, storing, and providing access to aggregate claims file data, said aggregate claims file data representing claims for workers compensation benefits under a plurality of workers compensation insurance policies, said aggregate claims file data including unstructured text fields that contain unstructured text information, said data storage module also receiving, storing and providing access to policy data that relates to said plurality of workers compensation insurance policies;
a text mining component, coupled to the data storage module, for determining whether to identify a one of said workers compensation insurance policies for referral to an investigation unit, wherein said determining includes analyzing unstructured text information contained in aggregate claims file data for said one of said workers compensation insurance policies, said analyzing for detecting at least one indicator of premium fraud in said unstructured text information;
a computer processor, coupled to the data storage module, for executing programmed instructions and for storing and retrieving said aggregate claims file data and said policy data;
program memory, coupled to the computer processor, for storing program instruction steps for execution by the computer processor;
an output device, coupled to the computer processor, for outputting an output indicative of whether said one of said workers compensation insurance policies should be referred to the investigation unit, wherein the computer processor generates the output in accordance with program instructions in the program memory and executed by the computer processor, said output generated in response to analyzing the unstructured text information contained in the aggregate claims file data for said one of said workers compensation insurance policies; and
a routing module for directing workflow based on the output from the output device.

2. The computer system of claim 1, wherein the text mining component is configured with at least one rule for identifying an indicator of premium fraud in said analyzed unstructured text information.

3. The computer system of claim 2 wherein each of said claims is brought by a respective claimant under one of said workers compensation insurance policies that is issued to a respective policy holder.

4. The computer system of claim 3, wherein the at least one rule includes a rule for detecting a phrase that indicates that the respective claimant is not an employee of the respective policy holder.

5. The computer system of claim 3, wherein the at least one rule includes a rule for detecting a phrase that indicates that the claimant received wages in cash.

6. The computer system of claim 3, wherein the at least one rule includes a rule for detecting a phrase that indicates that the claimant is an illegal alien.

7. The computer system of claim 3, wherein the at least one rule includes a rule for detecting a phrase that indicates that the claimant does not have a Social Security number.

8. The computer system of claim 2, wherein said at least one rule includes a phrase definition, said phrase definition indicative of a plurality of alternative phrase forms having a common meaning, said phrase definition for triggering detection of any one of said plurality of alternative phrase forms.

9. The computer system of claim 8, wherein said phrase definition includes: (a) a root phrase that serves as a label for the phrase definition; (b) a plurality of alternative phrase forms each formed by concatenating a plurality of terms; and (c) for each of at least some of said terms, one or more equivalent terms selected as being identical or equivalent to said each term.

10. The computer system of claim 9, wherein some of said terms are wild card terms.

11. The computer system of claim 1, wherein said unstructured text fields include one or more of claim handlers' text assessments of claims, claim handlers' notes of conversations, text of electronic mail messages imported into the aggregate claims file data, and comments from supervisors of claims handlers.

12. The computer system of claim 1, further comprising:
a scoring component, coupled to the text mining component, for assigning a respective score to each one of said workers compensation insurance policies identified by the text mining component for referral to the investigation unit, said respective score indicative of a likelihood that premium fraud is present in said each one of said workers compensation insurance policies.

13. The computer system of claim 1, further comprising:
a policy data analysis component, coupled to the text mining component, for analyzing said policy data and for cooperating with the text mining component in determining, based on said analyzed policy data, whether to identify said one of said workers compensation insurance policies for referral to the investigation unit.

14. The computer system of claim 1, further comprising a language translation component, coupled to the data storage module, for translating said unstructured text information from a first language to a second language, said text mining component analyzing said unstructured text information in said second language.

15. A computer system comprising:
a data storage module for receiving, storing, and providing access to aggregate claims file data, said aggregate claims file data representing claims made under a plurality of insurance policies, said aggregate claims file data including unstructured text fields that contain unstructured text information, said data storage module also receiving, storing and providing access to policy data that relates to said plurality of insurance policies;
a text mining component, coupled to the data storage module, for determining whether to identify a one of said insurance policies for referral to an investigation unit, wherein said determining includes analyzing unstructured text information contained in aggregate claims file data for said one of said insurance policies, said analyzing for detecting at least one indicator of premium fraud in said unstructured text information;
a computer processor, coupled to the data storage module, for executing programmed instructions and for storing and retrieving said aggregate claims file data and said policy data;
program memory, coupled to the computer processor, for storing program instruction steps for execution by the computer processor;
an output device, coupled to the computer processor, for outputting an output indicative of whether said one of said insurance policies should be referred to the investigation unit, wherein the computer processor generates the output in accordance with program instructions in the program memory and executed by the computer processor, said output generated in response to analyzing the unstructured text information contained in the aggregate claims file data for said one of said insurance policies; and
a routing module for directing workflow based on the output from the output device.

16. The computer system of claim 15, wherein the text mining component is configured with at least one rule for identifying an indicator of premium fraud in said analyzed unstructured text information.

17. The computer system of claim 16, wherein said at least one rule includes a phrase definition, said phrase definition indicative of a plurality of alternative phrase forms having a common meaning, said phrase definition for triggering detection of any one of said plurality of alternative phrase forms.

18. The computer system of claim 17, wherein said phrase definition includes: (a) a root phrase that serves as a label for the phrase definition; (b) a plurality of alternative phrase forms each formed by concatenating a plurality of terms; and (c) for each of at least some of said terms, one or more equivalent terms selected as being identical or equivalent to said each term.

19. The computer system of claim 18, wherein some of said terms are wild card terms.

20. The computer system of claim 15, wherein said unstructured text fields include one or more of claim handlers' text assessments of claims, claim handlers' notes of conversations, text of electronic mail messages imported into the aggregate claims file data, and comments from supervisors of claims handlers.

21. The computer system of claim 15, further comprising:
a scoring component, coupled to the text mining component, for assigning a respective score to each one of said insurance policies identified by the text mining component for referral to the investigation unit, said respective score indicative of a likelihood that premium fraud is present in said each one of said insurance policies.

22. The computer system of claim 15, further comprising:
a policy data analysis component, coupled to the text mining component, for analyzing said policy data and for cooperating with the text mining component in determining, based on said analyzed policy data, whether to identify said one of said insurance policies for referral to the investigation unit.

23. The computer system of claim 15, further comprising a language translation component, coupled to the data storage module, for translating said unstructured text information from a first language to a second language, said text mining component analyzing said unstructured text information in said second language.

24. A method of operating a computer system to identify premium fraud in workers compensation insurance policies, the method comprising:
storing aggregate claims file data in the computer system, said aggregate claims file data representing claims for workers compensation benefits under a plurality of workers compensation insurance policies, said aggregate claims file data including unstructured text fields that contain unstructured text information;
storing policy data in the computer system, said policy data relating to said plurality of workers compensation insurance policies;
using in said computer system a text mining tool to define at least one rule for identifying at least one indicator of premium fraud in said unstructured text information;
automatically analyzing said unstructured text information in said stored aggregate claims file data by using said at least one rule and said text mining tool to select ones of said workers compensation insurance policies, said selected ones of said workers compensation insurance policies corresponding to ones of said claims for which said analyzing identified said at least one indicator of premium fraud;
generating output signals in the computer system, said output signals including portions of said policy data, said portions of said policy data corresponding to said selected ones of said workers compensation insurance policies, said output signals also including data that represents said at least one indicator of premium fraud identified by said analyzing; and
outputting said output signals from said computer system.

25. The method of claim 24, wherein said at least one rule includes a phrase definition, said phrase definition indicative of a plurality of alternative phrase forms having a common meaning, said phrase definition for triggering detection of any one of said plurality of alternative phrase forms.

26. The method of claim 24, wherein said unstructured text fields include one or more of claim handlers' text assessments of claims, claim handlers' notes of conversations, text of electronic mail messages imported into the aggregate claims file data, and comments from supervisors of claims handlers.

27. The method of claim 24, further comprising:
assigning a respective score to each one of said selected workers compensation insurance policies, said respective score indicative of a likelihood that premium fraud is present in said each one of said workers compensation insurance policies.

28. The method of claim 24, further comprising:
analyzing said policy data in determining whether to select said one of said workers compensation insurance policies.

29. The method of claim 24, further comprising:
translating said unstructured text information from a first language to a second language, said analyzing said unstructured text information being performed in said second language.
